(19) United States
(12) Patent Application Publication
(10) Pub. No.: US 2007/0158611 A1
(43) Pub. Date: Jul. 12, 2007

(54) Compositions comprising nanorods and methods of making and using them

(76) Inventor: Steven J. Oldenburg, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/593,433

(22) Filed: Nov. 6, 2006

Related U.S. Application Data
(60) Provisional application No. 60/734,401, filed on Nov. 8, 2005.

(51) Int. Cl. C09K 5/00

(52) U.S. Cl. 252/71

(57) ABSTRACT

The invention relates to compositions comprising nanorods and methods of making and using the same. The inclusion of nanorods can enhance the thermal conductivity of a heat-transfer medium.

### CROSS-REFERENCE TO RELATED APPLICATIONS

This application claims the benefit and priority to the provisional U.S. Patent Application Ser. No. 60/734,401 filed on Nov. 8, 2005 which is incorporated by reference herein in its entirety.

### STATEMENT REGARDING FEDERALLY SPONSORED R&D

Portions of this invention may have been made with United States Government support under National Aeronautics and Space Administration contract NNM05AA35C. As such, the United States Government may have certain rights in the invention.

### BACKGROUND OF THE INVENTION

1. Field of the Invention

The invention relates to compositions comprising nanorods and methods of making and using the same. These compositions can be characterized by an enhanced thermal conductivity.

2. Description of the Related Art

Heat-transfer compositions are important for both heating and cooling of machinery, vehicles, instruments, devices, and industrial processes. Such heat-transfer compositions are used to transfer heat from one part of a system to another part of the system, or from one system to another system, typically from a heat source (e.g., a vehicle engine, boiler, computer chip, or refrigerator), to a heat sink. The heat-transfer composition provides a thermal path or channel between the heat source and the heat sink. The heat-transfer composition may be circulated through a loop system or other flow system to improve heat flow between the heat source and the heat sink or the heat-transfer composition may be in a static configuration between the heat source and heat sink.

By increasing the thermal conductivity of a heat-transfer composition, the efficiency of the heat transfer is improved and/or the required volume of the heat-transfer fluid can be reduced in applications. This could lead to more efficient, smaller, cheaper, and/or less-polluting devices utilizing heat-transfer compositions. Therefore, a need exists in the art for compositions and methods that can significantly increase the thermal conductivity of a base material.

### SUMMARY OF THE INVENTION

An embodiment provides a composition comprising:
a carrier; and
an amount of metal nanorods dispersed in the carrier that is effective to provide the composition with a thermal conductivity that is substantially different from the thermal conductivity of a comparable composition not containing the metal nanorods,
wherein the metal nanorods are characterized by lengths along a first principle axis, a second principle axis and a third principle axis, wherein:
   the axial length along the first principle axis is greater than or equal to the axial length along the second principle axis;
   the axial length along the second principle axis is greater than or equal to the axial length along the third principle axis;
   the axial length along the first principle axis divided by the axial length of the second principle axis is greater than about three; and
   at least one of the axial lengths is less than about 500 nm.

Another embodiment provides a method of making a metal nanorod composite material, comprising intermixing a base material with an amount of metal nanorods that is effective to form a composite material having a thermal conductivity substantially different from the thermal conductivity of a comparable composite material not containing the metal nanorods, wherein the metal nanorods are characterized by lengths along a first principle axis, a second principle axis and a third principle axis, wherein:
the axial length along the first principle axis is greater than or equal to the length along the second principle axis;
the axial length along the second principle axis is greater than or equal to the length along the third principle axis;
the axial length along the first principle axis divided by the length of the second principle axis is greater than about three; and
at least one of the axial lengths is less than about 500 nm.

Another embodiment provides a method of using a metal nanorods composition, comprising contacting a substrate with the metal nanorod composition, wherein the composition comprises metal nanorods dispersed in a base material in an amount effective to form a composite material having a thermal conductivity substantially different from the thermal conductivity of a comparable composition not containing the metal nanorods, wherein the metal nanorods are characterized by lengths along a first principle axis, a second principle axis and a third principle axis, wherein:
the axial length along the first principle axis is greater than or equal to the length along the second principle axis;
the axial length along the second principle axis is greater than or equal to the length along the third principle axis;
the axial length along the first principle axis divided by the axial length of the second principle axis is greater than about three; and
at least one of the axial lengths is less than about 500 nm.

These and other embodiments are described in greater detail below.

### BRIEF DESCRIPTION OF THE DRAWINGS

FIG. 1 is a diagram of nanorods dispersed in a fluid.

FIG. 2 is a photomicrograph of silver nanorods.

FIG. 3 is a photomicrograph of silver nanorods coated with a silica shell.

FIG. 4 is a plot of thermal conductivity as a function of silver nanorod concentration in deionized water and ethylene glycol.

FIG. 5 is a schematic diagram illustrating a configuration of a heat sink, computer chip, and heat transfer composition.

### DETAILED DESCRIPTION OF THE PREFERRED EMBODIMENTS

Embodiments of this invention provide composite materials comprising nanostructures, along with methods and compositions for making such composites. In some embodiments, the nanostructures are nanorods. In preferred embodiments, the nanostructures are metal nanorods, e.g., silver nanorods. The nanorods can be added to a carrier in order to substantially change the thermal conductivity of the carrier. Surprisingly, the addition of nanorods provides substantially greater improvements in thermal conductivity than the addition of other nanostructures.

Unless defined otherwise, all technical and scientific terms used herein have the same meaning as commonly understood by one of ordinary skill in the art to which the invention pertains. Supplied definitions supplement those in the art and are directed to the current application and are not to be imputed to any related or unreleased case, e.g., to any commonly owned patent or application. Although any materials and methods similar or equivalent to those described herein can be used in the practice or testing of the present invention, a variety of preferred materials and methods are described herein. Accordingly, the terminology used herein is for the purpose of describing particular embodiments only, and is not intended to be limiting. As used in this specification and the appended claims, the singular forms “a”, “an” and “the” include plural referents unless the context clearly dictates otherwise. Thus, for example, reference to “a nanorod” includes a plurality of nanorods, and the like.

### Physical Properties of Nanorods

Types of Nanostructures

A “nanostructure” is a structure having at least one region or characteristic dimension with a dimension of less than about 1000 nm, e.g., less than about 500 nm, less than about 200 nm, less than about 100 nm, less than about 50 nm, or less than about 20 nm. Typically, the region or characteristic dimension will be along the smallest axis of the structure. Examples of such structures include nanoparticles, nanorods, nanotubes, branched nanocrystals, nanodots, quantum dots, branched multipods (e.g., inorganic dendrimers), and the like. Nanostructures can be substantially homogeneous in material properties, or in certain embodiments can be heterogeneous (e.g. heterostructures). Nanostructures can be, e.g., substantially crystalline, substantially monocrystalline, polycrystalline, amorphous, or a combination thereof.

Nanostructures can be characterized by lengths along a first principle axis, a second principle axis, and a third principle axis, wherein the length along the first principle axis is greater than or equal to the length along the second principle axis, and the length along the second principle axis is greater than or equal to the length along the third principle axis. In some embodiments, the length along a principle axis can be variable with respect to position within the nanostructure. For example, the diameter of a rod might increase towards the center of the rod. In such embodiments, the length along the principle axis can be defined as equal to the minimum, maximum, or average length along that axis. If not specified, the length along the principle axis shall be defined as the average length along that axis.

In some aspects of the invention, the nanostructures referred to throughout can be nanoparticles. A “nanoparticle” is a nanostructure that can be suspended in a solid, liquid, or gas medium as an isolated entity. In one aspect nanoparticles are separated from other nanoparticles. In another aspect the nanoparticles are bound together in an aggregate where the aggregate can be suspended in a solid, liquid, or gas medium as an isolated entity.

In preferred embodiments, the nanostructures can be nanorods. Nanorods can be distinguished from other nanostructures by having a first principle axis that is significantly longer than both the second and the third principle axes. The definition of nanorods does not encompass flake, platelet, or planar nanostructures that are defined to have first and second principle axes that are significantly larger than the third principle axis. The “aspect ratio” of a nanorod is defined as the length along the first principle axis divided by the length along the second principle axis. For example, the aspect ratio for a nanorod with a circular cross section would be the length of its long axis divided by the diameter of a cross-section perpendicular to (normal to) the first principle axis. “Highly-anisotropic” refers to an aspect ratio greater than about 2, e.g., greater than about 3, greater than about 5, greater than about 10, greater than about 30, greater than about 100, greater than about 300, or greater than about 1,000. The second principle axis of a nanorod is typically less than about 1000 nm, optionally less than about 500 nm, preferably less than about 200 nm, more preferably less than about 150 nm, and most preferably less than about 100 nm, e.g., about 75 nm, or about 50 nm, or even less than about 25 nm or about 10 nm. The first principle axis of a nanorod is typically greater than about 10 nm, e.g., greater than about 20 nm, greater than about 50 nm, greater than about 100 nm, greater than 200 nm, greater than 500 nm, greater than 1000 nm, greater than 3,000, or greater than 10,000 nm. Nanorods typically have an aspect ratio greater than or equal to about 2, e.g., greater than or equal to about 3, 5, 7, 10, 20, 30, 50, 100, 200 or 1000. The cross section of a nanorod is defined as a plane that is perpendicular to the first principle axis. The cross section of a nanorod can be approximated by a circle, an ellipse, a rectangle, a polygon, or any other shape. The cross section of a nanorod can be different at different locations along the nanorod. Nanorods can be substantially homogeneous in material properties, or in certain embodiments can be heterogeneous (e.g. nanorod heterostructures). Nanorods can be fabricated from essentially any convenient material or materials and thus can be, e.g., substantially crystalline, substantially monocrystalline, polycrystalline, or amorphous. Nanorods can have a variable diameter or can have a substantially uniform diameter, that is, a diameter that shows a variance less than about 50%, less than about 20%, less than about 10%, less than about 5%, or less than about 1% over the region of greatest variability and over a linear dimension of at least 5 nm, at least 10 nm, at least 30 nm, or at least 100 nm. Typically the diameter is evaluated away from the ends of the nanorod (e.g. over the central 20%, 40%, 50%, or 80% of the nanorod). A nanorod can be straight or can be not straight, such as curved or bent, over the entire length of its long axis or a portion thereof.

Nanorods can be crystalline in some embodiments and are substantially crystalline in preferred embodiments. The term “crystalline”, when used with respect to nanorods, refers to nanorods that exhibit long-range ordering across one or more dimensions of the structure. It will be understood by one of skill in the art that the term “long-range ordering” will depend on the absolute size of the specific nanorods, as ordering for a single crystal cannot extend beyond the boundaries of the crystal. In this case, “long-range ordering” will mean substantial order across at least the majority of the dimension of the nanorod. In some instances, a nanorod can bear an oxide or other coating, or can comprise a core and at least one shell. In such instances it will be appreciated that the oxide, shell(s), or other coating need not exhibit such ordering (e.g. it can be amorphous, polycrystalline, or otherwise). In such instances, the phrase “crystalline,” “substantially crystalline,” “substantially monocrystalline,” or “monocrystalline” refers to the central core of the nanorod (excluding the coating layers or shells). The terms “crystalline” or “substantially crystalline” as used herein are intended to encompass structures comprising various defects, stacking faults, atomic substitutions, and the like, as long as the structure exhibits substantial long-range ordering (e.g., order over at least about 80% of the length of at least one axis of the nanorod or its core). In addition, it will be appreciated that the interface between a core and the outside of a nanorod or between a core and an adjacent shell or between a shell and a second adjacent shell may contain non-crystalline regions and may even be amorphous. This does not prevent the nanorod from being crystalline or substantially crystalline as described herein.

Metal nanorods can be made by various methods known to those skilled in the art. One detailed method of making silver nanorods is included below. In an embodiment, compositions and methods involve metal nanorods that are produced using a polyol method, see, e.g., U.S. Pat. No. 4,539,041 and Sun et al. Nano Lett. (2002) 2:165-168, both of which are herein incorporated by reference and particularly for the purpose of describing methods of making nanorods. Other methods of making anisotropic particles can also be used. These include but are not limited to the use of cetyl trimethyl ammonium bromide mediated growth recipes (e.g., Busbee, Adv. Mater. (2003) 15:414-416, incorporated herein by reference), water-based nanorod protocols (e.g., Caswell, Nano Lett. (2003) 3:667-669, incorporated herein by reference), organic solvent based protocols, micellular fabrication protocols, and templated assembly in the pores of filters (e.g., Cepak, Chem. Mater. (1997) 9:1065-1067, incorporated herein by reference). Within a composition comprising the nanorods, there may be a large distribution in the length or aspect ratio of the nanorods. Alternatively, the nanorods may be of approximately equal length or have approximately equal aspect ratios.

In preferred embodiments, compositions comprising metal nanorods are characterized by an increase in thermal conductivity as compared to comparable compositions not containing the nanorods, and/or as compared to comparable compositions comprising non-nanorod nanostructures in place of the nanorods. As used herein, comparable compositions can refer to compositions containing substantially the same components as the nanorod composition except without the metal nanorods. In some embodiments, the comparable compositions can refer to compositions containing substantially the same components as the nanorod composition but containing non-nanorod nanostructures in place of the nanorods. In some of these embodiments, the volume and volume size distribution of the non-nanorod nanostructures is approximately the same as that of the nanorods, e.g., the average volume of the nanorods in a nanorod composition is substantially the same as the average volume of nanospheres in the comparable composition. In some embodiments, the non-nanorod nanostructures are composed of the same materials, and in some embodiments in the same percentage amounts, as the nanorods. Such embodiments can indicate that the non-nanorod nanostructures have similar coatings as the coatings of the nanorods. The non-nanorod nanostructures can be present in the same volume concentration, mass concentration, or element concentration (wherein element concentration refers to the number of nanostructures per unit volume) as the nanorods are in the composition.

In some preferred embodiments, the thermal conductivity of a nanorod composition comprising metal nanorods and a carrier is greater than a comparable composition containing the same components as the nanorod composition but containing metal nanospheres in place of the nanorods, wherein the average volume and volume size distribution of the nanospheres is approximately the same as that of the nanorods. In more preferred embodiments, the nanospheres are composed of and coated with similar materials as are the nanorods. In some preferred embodiments, the thermal conductivity of the nanorod composition is at least about 5% greater than the thermal conductivity of the comparable composition containing metal nanospheres, while in other preferred embodiments, the thermal conductivity of the nanorod composition is at least about 10%, 20%, 30%, or 50% greater than the comparable composition containing metal nanospheres.

Shapes

The shape of nanorods can be characterized by the length of the first principal axis and the cross section of the nanorod, which is defined as the intersection of the nanorod with a plane that is perpendicular to the first principal axis. In some embodiments, the cross section of the nanorod can be approximated by a circle, triangle, square, pentagon, polygon with 4, 5, 6, 7, 8, or 9 sides, donut, ellipse, hollow ellipse, or other hollow shape. In some embodiments the cross section is an irregular shape. It is an aspect of this invention that the cross section of the nanorod be a different shape at different locations along the first principal axis. In some embodiments, the nanorod consists of a core-shell geometry. In some embodiments the core is a metal. In other embodiments the shell is a metal. Metal shelled materials can be formed using an electroless deposition technique designed for coating dielectric nanoparticles with a thin layer of metal (see, e.g., Oldenburg, Chem. Phys. Lett. (2002) 288:243-247, incorporated by reference). In other embodiments the nanorods have a hollow interior. Hollow nanorods can be produced via the dissolution of the core of metal shelled nanomaterials (see, e.g., Liang, Chem. Mater. (2003) 15:3176-3183, incorporated herein by reference). Further, nanorods can be linked to other nanorods and/or planar arrays. All embodiments described herewith with reference to nanorods of one shape can also be applied to all other nanorods.

Within a composition comprising the nanorods, there may be a large distribution in the shapes of the nanorods. Alternatively, the nanorods may be of approximately the same shape.

Materials

Metal nanorods are metal nanostructures comprising at least about 30% metal by weight. When the metal nanorods are coated, then the metal-containing core comprises at least about 30% metal by weight. The metal can be selected from the group consisting of titanium, zirconium, hafnium, vanadium, niobium, tantalum, chromium, molybdenum, tungsten, manganese, technetium, rhenium, osmium, cobalt, nickel, zinc, scandium, yttrium, lanthanum, a lanthanide series element (e.g., cerium, praseodymium, neodymium, promethium, samarium, europium, gadolinium, terbium, dysprosium, holmium, erbium, thulium, ytterbium, and lutetium), aluminum, gallium, indium, thallium, germanium, tin, lead, magnesium, calcium, strontium, barium, gold, silver, copper, and iron. Metal nanorods can, in some embodiments, comprise a metal containing material including but not limited to aluminum nitride, aluminum oxide, barium sulfate, barium titanate, hematite, indium hydroxide, indium oxide, indium tin oxide, iron oxide, iron sulphide, lead oxide, molybdenum oxide, titanium dioxide, titanium nitride, titanium oxide, tungsten carbide, tungsten oxide, zinc oxide, zinc sulfide, and zirconium oxide. In some embodiments, the metal nanorods comprise an alloy of one or more metals. In some embodiments, at least a portion of the nanorods comprise an electrically-conductive material. The conductive material can be a conductive polymer. In preferred embodiments, the conductive material can be one or more metals selected from the group consisting of nickel, iron, gold, silver, copper, and aluminum. In the more preferred embodiments, the nanorods comprise silver. Metal nanorods may comprise carbon, but carbon nanorods (e.g. carbon nanotubes) that consist entirely or primarily of carbon are not metal nanorods.

Nanorods can be heterostructures, wherein the term “heterostructure” refers to nanorods characterized by at least two different and/or distinguishable material types. Typically, one region of the nanorod heterostructure comprises a first material type, while a second region of the nanorod heterostructure comprises a second material type. In certain embodiments, the nanorod comprises a core of a first material and at least one shell of a second (or third, fourth, etc.) material, wherein the different material types are distributed radially about the long axis of a nanorod, for example. A shell need not completely cover the adjacent materials to be considered a shell or for the nanorod to be considered a heterostructure; for example, a nanorod comprising a core of one material and small islands of a second material overlying the shell is a nanorod heterostructure.

Coatings

Metal nanorods can comprise a coating that encapsulates or covers part or all of the nanorods. In some embodiments, a portion of all of the metal nanorods in a composition can be fully encapsulated with one or more coatings. In other embodiments, a portion or all of the metal nanorods in a composition can be partially encapsulated with one or more coatings. In still other embodiments, all of the metal nanorods in a composition can be fully encapsulated with one or more coatings.

Non-limiting examples of suitable nanorod coatings include: silica coatings, polystyrene coatings, hydrophobic coatings, hydrophilic coatings, porous coatings, magnetic coatings, and fluorescent coatings, and combinations thereof. Suitable methods known to those skilled in the art can be used to make coated nanorods. For example, metal and metal containing nanorods can be coated with silica using sol gel methods, as a wide variety of different silanes can be condensed onto the surface of a nanorod without inducing nanorod aggregation (see, e.g., Hardinkar, J. Coll. Int. Sci. (2002) 221:133-136 and Liu, Nanotechnology (2003) 14:813-819, incorporated herein by reference). Nanorods can be coated with polystyrene using methods described in Bao, Colloid. Polym. Sci. (2005) 283:653-661, incorporated herein by reference. Hydrophobic coatings can be obtained by encapsulating the nanorods with a silica coating formed via the condensation of silane molecules with hydrophobic functional groups. For example, the condensation of fluorosilane derivatives such as (tridecafluoro-1,1,2,2-tetrahydrooctyl) triethoxysilane and (heptadecafluoro-1,1,2,2,-tetrahydrodecyl) triethoxysilane onto the surface of the nanorods will render the surface of the nanoparticles hydrophobic. Coatings can further change the charge of the particle, present specific chemical functional groups on the nanorod, and/or degrade with time. Multiple layers of coatings are contemplated with one or more of the layers being complete or incomplete. Binding of one or more nanoparticles to the surface of the nanorods is also contemplated. The binding of nanoparticles to the nanorods can be accomplished via charge mediated assembly techniques as described in Westcott, Chem. Phys. Lett. (1999) 300:651-655, incorporated herein by reference.

In some embodiments, the coated nanorods can be substantially electrically insulating. In an embodiment, the coated nanorods comprise a thin coating film that is substantially electrically insulating and that has a sheet resistance that is greater than 100, 1,000, 10,000, or 100,000 Ohms/square.

Base Materials or Carriers

Nanorods can be utilized in a wide variety of heat transfer media, including but not limited to heat transfer media currently used in industrial, government, and/or research applications. The heat transfer media (which may be referred to herein as a carrier or base material), with which the nanorods are intermixed to form a heat transfer composition, can be a solid, a paste, or a liquid. The nanorods may be incorporated into a liquid having a relatively low viscosity that is suitable for flowing over a substrate from or to which heat transfer is desired, or may be incorporated into a relatively high viscosity material (such as a paste, polymer or soft compound) that is suitable for positioning near or in contact with such a substrate. In other embodiments, the base material or carrier may be polymerized or otherwise processed to yield a solid that contains the nanorods. Surprisingly, in preferred embodiments the addition of effective amounts of nanorods to the base material improves thermal conductivity to a greater degree than the addition of other nanostructures.

Heat-transfer media, with which the nanorods can be intermixed to form a heat transfer composition, include but are not limited to fluoroinert compounds (e.g., fluorinated hydrocarbons, FC series by 3M), organic solvents, chlorofluorocarbons (e.g., R-113), water, glycol based solvents, polymers, epoxies, greases, and oils. Specifically, the base material can comprise any substance selected from the group consisting of: water, a salt solution, an alcohol, a glycol, an ammonia solution, a hydrocarbon, a mineral oil, a natural oil, a synthetic oil, a fat, a wax, an ether, an ester, a glycol, a silicate ester, a biphenyl solution, a polyaromatic compound, a salt-hydrate, an organic eutectic, a clathrate-hydrate, a paraffin, and an inorganic and organic eutectic mixture and combinations thereof. The base material can comprise any halogen derivative of a substance selected from the group consisting of: a hydrocarbon, a mineral oil, a natural oil, a synthetic oil, a fat, a wax, an ether, an ester, and a glycol and combinations thereof. The base material can be characterized by a high viscosity that is greater than or equal to about 1 cP, e.g., greater than or equal to 2, 5, 10, 20, 50, 80, 100, 200, 300, 400, 500, 750, 1,000, 2,000, 3,000, 5,000, 10,000, or 15,000 cP. The base material can be characterized by a low viscosity that is less than about 15,000 cP, e.g., less than about 10,000, 5,000, 3,000, 2,000, 1,000, 750, 500, 400, 300, 200, 100, 80, 50, 20, 10, 5, or 2 cP. In an aspect, the nanorods are dispersed throughout the base material. In another aspect, the nanorods are concentrated in one or more regions of the base material.

Compositions Comprising Nanorods

In some embodiments, the present invention includes nanorod compositions comprising metal nanorods and a carrier. The concentration of the nanorods in the nanorod composition can be at least about 0.05%, e.g., at least about 0.05%, 0.1%, 0.2%, 0.3%, 0.5%, 1.0%, 2.0%, 3.0%, 5.0%, or 10.0%, by volume of the composition. The volume concentration is defined as the mass concentration of the nanorod divided by the density of the nanorod. For heterogeneous nanorods that, for example, include a coating, the density of the nanorod is the density of all components of the heterogeneous nanorod. Nanorod compositions comprising metal nanorods and a carrier metal may be referred to herein as nanorod composite materials. The concentration of the nanorods in the composition can be at least about 0.3%, e.g., at least about 0.3%, 0.4%, 0.5%, 1.0%, 2.0%, 3.0%, 5.0%, 10.0%, 30%, 50% or 75%, by mass of the composition. In some embodiments, the concentration of the nanorods in composition can be less than or equal to about 50.0%, e.g., less than or equal to about 30.0%, 10.0%, 5.0%, 3.0%, 2.0%, 1.0%, 0.5%, 0.3%, 0.2%, 0.1%, 0.05%, 0.03%, 0.02%, or 0.01%, by volume or by mass of the composition. Thus, the concentration of the nanorods in the composition can be within any of the above limits. For example, in some embodiments, the concentration of nanorods in the composition can be at least about 0.1% and less than or equal to about 50.0% by volume of the composition.

Nanorod compositions can be made in various ways. Preferably, the nanorods are formed in situ in the form of a suspension or dispersion at very low concentrations, concentrated while carefully maintaining the suspended or dispersed state, then added in a concentrated form to a heat transfer medium or carrier to form a nanorod composite material. To concentrate the nanoparticles, the nanorods can, for example, be exposed to a vacuum, centrifuged, evaporated, and/or filtered in order to increase the concentration of the nanorods in the composition. In a preferred embodiment, the method used to concentrate the nanorods does not permanently aggregate the nanorods. The nanorod composition can be combined with other compositions comprising different concentrations (including, e.g., a zero concentration) of nanorods in order to further change the concentration. In some embodiments, the nanorods are concentrated and redispersed in a second material before transferring the concentrated nanorods to the base material or carrier. In some embodiments, the second material is the same as the base material or carrier. In the preferred embodiment, more than 90%, e.g., more than 90%, 95%, 98%, or more than 99% of the original solution that the nanorods were prepared in is removed before transferring the nanorods to the base material or carrier. In other embodiments, the nanorods are dried into a powder before adding the nanorods to the base material or carrier

The nanorod composition can further comprise additional components, such as, but not limited to a surfactant, a colloidal stabilizer, a nanorod aggregation inhibitor, an antimicrobial agent, an anti-corrosive agent, a viscosity modifier, or a degradation stabilizer. Further, the composition can comprise additional nanostructures, such as, for example, non-nanorod nanostructures, e.g., nanospheres.

Thermal Properties

In some embodiments, a nanorod composition can comprise metal nanorods and a carrier. The thermal conductivity of the nanorod composition is a property that relates to the ability of the nanorod composition to conduct heat. Thermal conductivity depends on the amount of heat, Q, transferred through a distance, L, in a time, t, in a direction normal to a cross-sectional area, A, caused by a temperature difference, ΔT. Specifically, the thermal conductivity is equal to the amount of heat, Q, multiplied by the distance of the transferred heat, L, divided by the product of the cross-section area, A, the temperature difference, ΔT, and the time of the heat transfer, t, such that the thermal conductivity, k=Q·L/(A·ΔT·t).

The thermal conductivity of nanorod compositions described herein can be measured, in some embodiments, by using a hot-wire method. Briefly, an electrically heated wire is inserted into the nanorod composition. As the heat flows from the wire into the sample, the temperature of the wire is measured. The thermal conductivity can be determined by comparing the temperature of the wire to the logarithm of time. Devices such as the KD2 thermal conductivity meter employ this method.

In other embodiments, the thermal conductivity of nanorod compositions can be measured by using a modified hot-wire method. In these embodiments, a heated element is used in place of the electrically heated wire. The element is supported on a backing, thereby allowing single-directional heat flow. The thermal conductivity is then determined via methods described in the hot-wire method. The modified hot-wire method is more desirable when determining the thermal conductivity of liquid compositions. Devices such as the Mathis TCi Thermal Conductivity Testing System employ this method.

The thermal conductivity of the nanorod composition can be different than the thermal conductivity of a comparable composition not containing the nanorods. In some embodiments, the thermal conductivity of the nanorod composition can be substantially different than the thermal conductivity of the comparable composition. In preferred embodiments, the thermal conductivity of the nanorod composition can be substantially greater than the thermal conductivity of the comparable composition, wherein substantially can be defined as at least about 1% greater, e.g., at least about 2%, 3%, 5%, 10%, 20%, 30%, 40%, 50%, 70%, or 100%, greater than the thermal conductivity of the comparable composition.

The thermal conductivity of the nanorod composition can also be different than the thermal conductivity of a second comparable composition comprising non-nanorod nanostructures in place of the nanorods. In some embodiments, the thermal conductivity of the nanorod composition can be substantially different than the thermal conductivity of the second comparable composition. In preferred embodiments, the thermal conductivity of the nanorod composition can be substantially greater than the thermal conductivity of the second comparable composition. The thermal conductivity of the composition can be at least 1% greater, e.g., at least about 2%, 3%, 5%, 10%, 20%, 30%, 40%, 50%, 70%, or 100%, greater than the thermal conductivity of the second comparable composition.

Similarly, the thermal diffusivity and/or the specific heat of a nanorod composition comprising metal nanorods and a carrier can be different, substantially different, or substantially greater than a comparable composition not containing the nanorods or than a second comparable composition comprising non-nanorod nanostructures in place of the nanorods.

In some embodiments, the change in thermal conductivity is not a result of aligned or partially aligned nanorods. Aligning the nanorods can have a further effect on properties, especially thermal properties, of the composition. Included as an embodiment of the invention is a composition comprising highly-anisotropic, preferably metal, aligned nanostructures and a carrier and methods of making and using them.

In preferred embodiments, the addition of metal nanorods increases the thermal conductivity of carriers to which they are added (such as fluids, pastes, or solids), even at relatively low loading densities. The heat-transferring properties of such carriers can therefore be improved by the metal nanorods. A “nanofluid” is a composition comprising a fluid and nanostructures. Embodiments of this invention include nanofluids comprising metal nanorods, wherein the nanostructures are dispersed throughout a fluid, and methods of making them. Dispersion of the nanostructures within a fluid can, but need not, use a dispersion device.

Nanorod compositions can contact a first surface of a substrate and a second surface, wherein the second surface can be a surface of a second substrate, which may be a liquid, a solid or a gas. The composition can provide a thermal conduction pathway from the first surface to the second surface. The thermal conduction provided by the composition can be greater than that provided by a comparable composition not containing nanorods or containing non-nanorod nanostructures in place or the nanorods or than that provided without the nanorod composition.

Operating Temperatures

It is an embodiment of this invention that a nanorod composition comprising a carrier and metal nanorods can function at a variety of temperatures. In some embodiments, the nanorod composition can operate at temperatures down to about −200° C., e.g., down to about −180° C., about −160° C., about −140° C., about −120° C., about −100° C., about −80° C., about −60° C., about −40° C., about −20° C., about 0° C., about 20° C., about 40° C., about 60° C., or below −200° C. In some embodiments, the nanorod composition can operate at temperatures up to about 0° C., e.g., up to about 50° C., about 100° C., about 150° C., about 200° C., about 250° C., about 300° C., about 400° C., about 500° C., about 600° C., about 700° C., about 800° C., about 900° C., about 1,000° C., or above 1,000° C. Variation on the nanorods, the concentration and coatings on such nanostructures, as well as the carrier that the nanorods are embedded in may need to be optimized for various temperature conditions.

Other Properties

The metal nanorod can be selected to have physical properties that enable one skilled in the art to optimize one or more properties of the nanorod composition, including but not limited to: heat capacity, viscosity, chemical stability, physical stability, range of operable temperatures, interactions with at least one other component of a cooling system, effects on non-heat related physical properties of the composition, anti-corrosive properties, non-flammable properties, anti-bacterial properties, and non-toxic properties. In some embodiments, selecting some physical properties of nanorods over other physical properties can result in an increase in the heat capacity, decrease in the viscosity, increase in the chemical stability, increase in the physical stability, increase in the range of operable temperatures, decrease in the probability of interaction with at least one other component of a cooling system, decrease in the effect on non-hear related physical properties of the composition, increase in the anti-corrosive properties, increase in the non-flammable properties, increase in the anti-bacterial properties, and/or increase in the non-toxic properties of the composition.

Applications

Nanorod compositions comprising a carrier and metal nanorods can be used to cool or heat a substrate. By contacting the substrate with the nanorod composition, a substrate can transfer heat to the nanorod composition, as the nanorod composition can be characterized by a high thermal conductivity.

The substrate can, for example, be a component of a heating system, a refrigeration system, a cooling system, an air conditioning system, an electronic device, an instrument, a vehicle, an aircraft, a spacecraft, a power generating system, a thermal storage system, a heat pipe system, a fuel cell system, a hot water system, or an automobile component.

The nanorod composition can be added to a coolant to change the thermal properties, such as to increase the thermal conductivity of the coolant in a cooling system. In some embodiments, nanorod compositions comprising metal nanorods can be incorporated into existing coolants. The addition of the nanorods may increase thermal conductivity performance without impacting the desired physical properties of the base fluid. In some embodiments, no retooling of the nanorod-augmented thermal control systems is necessary, and the nanofluids can be rapidly deployed into existing and future coolant loops.

Alternatively, the nanorod composition itself can act as a coolant. By incorporating a coolant that comprises a carrier and nanorods into a cooling system, the amount of coolant in the system can be reduced as compared to a system incorporating a comparable coolant lacking the nanorods. The nanorod composition can then be utilized in applications that are characterized by limited space for coolants, such as supercomputer circuits and/or high-power microwave tubes.

A nanorod composition comprising nanorods and a carrier can be passed across a surface of a substrate. In some embodiments, the nanorod composition is a liquid, and it can flow over the substrate. In some embodiments, by passing the nanorod composition across the surface of the substrate, heat transfer from the substrate can be enhanced. In one embodiment by passing the nanorod composition across the surface of the substrate, heat transfer from a substrate can be transferred to a second substrate that is physically separated from the first substrate by a relatively large distance. In one embodiment, the heat transferred when the nanorod composition is passed across the substrate's surface is greater than the heat that would be transferred if the nanorod composition was relatively stationary over the substrate's surface.

In a cooling system, by incorporating a coolant that comprises nanorods and a carrier, the time required to remove an amount of heat from a heat load by the system and/or the fluid flow of the coolant in the system can be reduced as compared to a system incorporating a comparable coolant lacking the nanorods. Further, the amount of heat that can be removed from a heat load by the system can be increased from that of a comparable system. A system incorporating a nanorod composition comprising a carrier and nanorods can reduce energy consumption as compared to a comparable system without nanorods.

A preferred nanorod composition comprising a carrier and metal nanorods can be characterized by a high heat capacity, high physical and/or chemical stability, a large range of operable temperatures, a reduced probability of interaction with at least one other material, minimal effect on non-heat related physical properties of the composition, anti-corrosive properties, non-flammable properties, anti-bacterial properties, and/or non-toxic properties. Therefore, the preferred nanorod composition can be used in any application in which at least one of these properties is desirable.

Further embodiments include using the nanorod composition in applications, in which it is useful to use a composition that is simultaneously characterized by high thermal capacity, high thermal conductivity and low viscosity. The nanorod composition can also be used in applications in which it is useful to use a composition that maintains high performance over the full-temperature range of the system and/or in applications in which it is useful to use a composition that is chemically stable at temperatures present in cooling and heating systems.

Further embodiments include using the nanorod composition in applications, in which it is useful to use a composition that is simultaneously characterized by high thermal conductivity and high viscosity. The high viscosity nanorod composition is useful, for example, in applications such as a viscous fan clutch where the stress in the fluid creates a torque that is transferred to a driven surface that relative to a drive surface.

In some embodiments, nanorod compositions comprising nanorods can perform as an antimicrobial agent. At the elevated temperatures present in coolant loops, the growth of bacteria and biofilms can reduce the heat transfer efficiency of the system, clog filters present in the heat transfer system, and induce biocorrosion. Compositions comprising nanorods that comprise certain metals (e.g. silver) that tend to be biocidal can reduce the concentration of bacteria and other living organisms in a coolant loop. In some embodiments, the nanorods are non-toxic to humans.

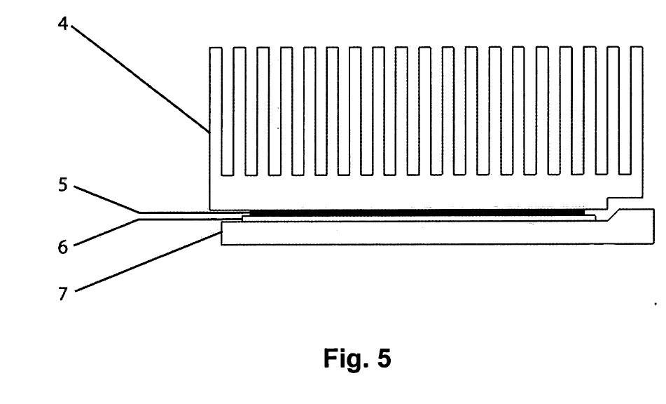

Compositions comprising metal nanorods can be positioned in a layer between a substrate and a second surface. Such a composition may be referred to as a thermal interface material. The layer can be less than about 100 mm in thickness, e.g., less than about 10 mm, 1 mm, 0.5 mm, 0.4 mm, 0.3 mm, 0.2 mm, 0.1 mm, 0.03 mm, 0.01 mm, 0.003 mm, or 0.001 mm. For example, when heat sinks are attached to microprocessor chips, a thermal interface material comprising metal nanorods can be utilized to ensure efficient thermal contact between the two components. FIG. 5 shows a computer chip 6 in a socket 7. A thermal interface material 5 is positioned on top of the computer chip 6, although the thermal interface material 5 can instead be generally in either direct and/or indirect contact with the computer chip 6. The thermal interface material 5 is also illustrated as being positioned below a heat sink 4, although it is understood that the thermal interface material 5 can more generally be in either direct and/or indirect contact with the computer chip 6. The thermal interface material 5 can be a paste or a solid. In some embodiments the thermal interface material 5 comprises nanorods in an amount that is effective to provide increased heat transfer from the computer chip 6 to the heat sink 4 as compared to that expected if the thermal interface material 5 did not contain nanorods or if the thermal interface material 5 was omitted.

Nanorods can be incorporated into very high viscosity or solid base materials to increase the thermal conductivity and/or electrical conductivity of the base material. Suitable base materials include but are not limited to electronic packaging materials, automobile panels and components, casing and enclosures for instruments, glass and other transparent materials. These nanorod compositions can also be useful for electrostatic discharge protection or protection against lightning strikes.

Embodiments of this invention can provide advantages over the use of nanorods in a powder form. In some cases, dried nanorods can be irreversibly aggregated and cannot be redisperesed in solution as individual particles. In an embodiment of the current invention, the nanorod compositions are not allowed to dry during the production of fluid nanorod compositions or nanofluids, and the resulting nanorod composition can have less aggregation than a nanofluid that is produced from nanorods in a powder form.

### EXAMPLES

The following examples describe various components of an embodiment of the current invention. This embodiment utilizes silver nanorods dispersed in water or ethylene glycol to increase the thermal conductivity and thermal diffusivity of the fluid.

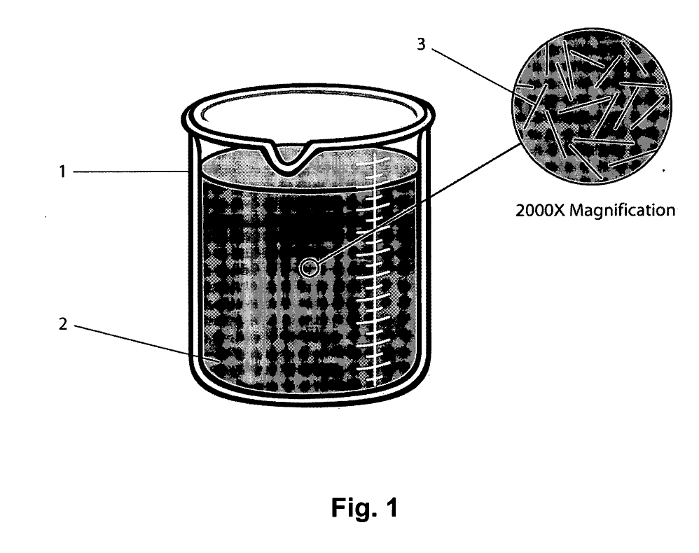

An embodiment of the invention is a nanorod composition that comprises nanostructures, specifically highly-anisotropic nanorods, dispersed in a medium. The medium can be a variety of different liquids, pastes, or solids. A diagram of a composition comprising nanorods and a thermal transfer fluid is shown in FIG. 1. Nanorods 3 are dispersed in a medium 2 contained in a container 1.

The description provided below illustrates an embodiment of the invention. In summary, crystalline silver nanorods dispersed in water or ethylene glycol were prepared. The silver nanorods were 70 nm in diameter and ˜6 μm in length (aspect ratio of 85). The silver nanorods were substantially crystalline and had a pentagonal cross-section. The thermal conductivity of the ethylene glycol carrier in which they were dispersed was enhanced by 53% at a silver nanorod volume concentration of 0.61%. When the nanorods were transferred to water, the thermal conductivity of the water was increased by 26% at a volume concentration of 0.46% of the silver nanorods.

### Example 1

### Silver Nanorod Production

Nanorods are produced in a high-temperature ethylene glycol reduction of silver salts in the presence of a stabilizing polymer. Methods for reducing metal salts in polyol (e.g., ethylene glycol) solutions were described previously in U.S. Pat. No. 4,539,041, Sun, et al., Nano. Lett. (2002) 2:165-168, and Sun, Chem. Mater. (2002) 14:4736-4735 and are incorporated herein by reference in their entirety. Crystalline silver nanorods are formed by heating 5 mL of ethylene glycol to 160° C. in an oil bath. 0.02 mg of PtCl₂ is dissolved into 0.5 mL of ethylene glycol and added to the 5 mL polyol solution. After 4 minutes, 2.5 mL of silver nitrate dissolved in ethylene glycol at a concentration of 20 mg/mL is added drop-wise for 5 minutes. 1 minute after the addition of the silver nitrate solution, 5 mL of polyvinylpyrrolidone in ethylene glycol prepared at a concentration of 40 mg/mL is added drop-wise for 5 minutes. The solution is maintained at 160° C. for 1-2 hours.

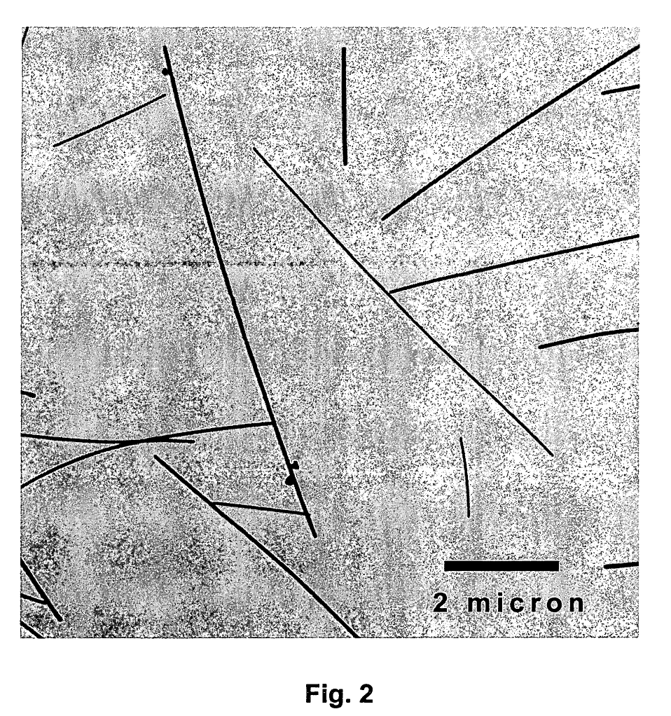

The fabricated silver nanorods have high aspect ratios, are not aggregated, and are crystalline. The silver concentration of the fabricated nanorods is 2.44 mg/mL which is equivalent to a mass concentration of 0.24% and a volume concentration of 0.023%. An image of a silver nanorod sample captured with a transmission electron microscope is shown in FIG. 2. It can be seen that the nanorods (shown in black) are not aggregated. Variation of the fabrication parameters allows for the production of silver rods that have diameters as small as ˜20 nm and lengths that are >20 μm. The thermal conductivity of the silver nanorods is expected to be extremely high as the nanorods are crystalline and there are less phonon scattering sites in the material when compared to non-crystalline formulations.

Different processing parameters such as reagent concentrations, molecular weight of stabilizing polymer, reagent addition timing, reagent addition rate, reaction temperature, mixing parameters, and reaction time can be varied in order to produce rods with different lengths and widths. In addition to rods, other shapes including but not limited to spherical, tetrahedral, cubic, and plate-like structures can be formed.

### Example 2

### Silica-Coating Reaction

In some embodiments of the invention it is useful to coat the nanorods with one or more coating layers to improve the properties of the nanorod. The silica coating of nanorods has been described previously in Yin, Nano Letters (2002) 2:427-430 and is incorporated herein by reference. To coat the nanorods with silica 2.44 mg of the silver nanorods was dispersed in 20 mL of 2-propanol and 4 mL of deionized water. 0.4 mL of ammonium hydroxide with an ammonia concentration of 30% was added. Sufficient tetraethylorthosilicate was added to obtain a final concentration of 0.072M. After 1 hour, the solution was centrifuged at ˜4000 rpm to isolate the precipitate and the silica coated nanorods were redispersed in deionized water.

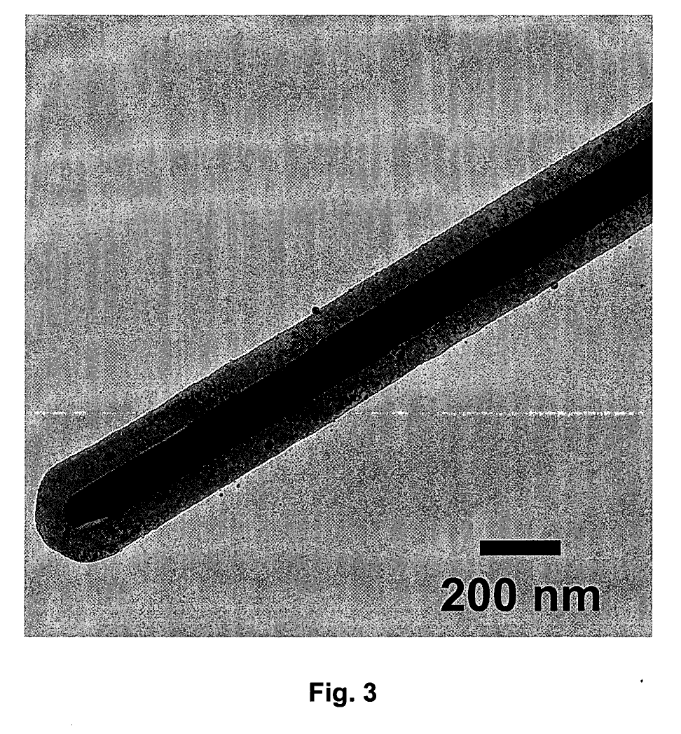

An example of a silica coating of a nanorod is shown in FIG. 3. This image was obtained with a transmission electron microscope. In this instance, the silver nanorod (shown in black) is coated with silica (shown in dark gray). Once the rod is coated with silica, the silica surface can be further modified using techniques well known in the art, such as those described in van Blaaderen, J. Coll. Int. Sci. (1993) 156:1-18, which is hereby incorporated in its entirety by reference. For example, to modify the surface of silica coated nanorods with an amine chemical group, 1 μL of 3-aminopropyltriethoxysilane was added to 100 μL of ethanol. 2.44 mg of silica coated silver nanorods was added to 8.5 mL of ethanol. 0.44 mL of ammonium hydroxide (30% ammonia) was added. 1.44 mL of water was added. The solution was heated to 40° C. for 1 hour and the silane was added over the period of 1 hour using a syringe pump.

A number of silane derivative are available through companies such as Gelest (Morrisville, Pa.). The use of all such silanes sold by Gelest and other chemical supply companies are incorporated herein by reference. The different silanes can alter the charge, chemical functionality, hydrophobicity, porosity, density, etc., of the nanorods.

### Example 3

### Rod Concentration and Transfer to Various Media

In one embodiment, silver nanorods are produced in an ethylene glycol carrier at a concentration of 2.44 mg/mL which is equivalent to a volume concentration of 0.023%. At this concentration, the added nanorods increase the thermal conductivity of the ethylene glycol base fluid by 2.5%. To achieve larger increases in the thermal conductivity of the carrier, the nanorod concentration in the carrier can be increased. Low speed (500×g) centrifugation can be used to concentrate the particles into a pellet allowing for higher concentration solutions to be fabricated or for the particles to be dispersed into other liquids. Alternatively, the nanorods can be concentrated using tangential flow filtration or a filter press. Alternatively, embodiments of the current invention will settle over a period of days to allow for concentration without centrifuging.

Once the nanorods have been concentrated into a small volume, the particles can be re-dispersed in another medium. This medium includes but is not limited to solvents such as water, oil, grease, ethanol, toluene, fluoroinert compounds, other heat transfer materials, organic solvents, and pastes. In some embodiments, the concentration and redispersion process may be repeated a number of times to remove unwanted residual reactants from solution. Alternatively, the base fluid of the nanostructures can be exchanged using dialysis or tangential flow filtration. Alternatively, the nanorods can be concentrated via the evaporation of the base fluid. Alternatively, the nanorods can be concentrated via the evaporation of solvents in a rotary evaporator. Alternatively, the nanorods can be concentrated by filtration. It may be necessary to functionalize the nanorods with a surface coating before the particles can be transferred to a new medium.

Nanorods can be incorporated into alternative materials including but not limited to plastics, ceramics, and composites. In order to be compatible for methods used to form these materials, the nanorod may need to be coated with one or more coating layers.

### Example 4

### Silver Nanorod Thermal Conductivity Measurements

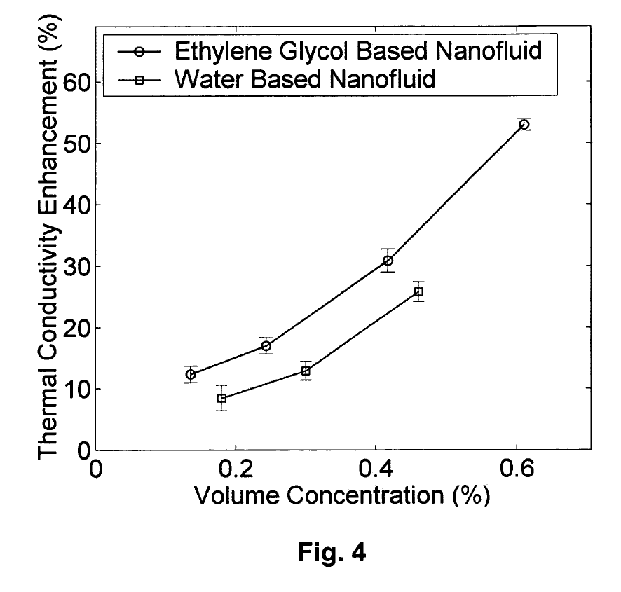

Crystalline silver nanorod particles were concentrated to a 0.61% volume concentration (6.4% mass concentration) in polyethylene glycol and the thermal conductivity enhancement of a dilution series was measured with a KD2 thermal conductivity meter by Decagon Devices. The probe uses a hot-wire method to measure the thermal conductivity and thermal diffusivity of the material. A specialized small volume cell was used for measuring 15 mL of the liquid. The thermal conductivity enhancement of silver nanorods in ethylene glycol and water is shown in FIG. 4. The thermal conductivity (y-axis) of compositions comprising nanorods and a carrier, wherein the carrier was either glycol or water, was measured as a function of the concentration of nanorods by volume α-axis). As the concentration of nanorods increased, the thermal conductivity of the compositions increased, either when the carrier of the composition was ethylene glycol (circles) or water (squares). All measurements were taken at a temperature of 25° C. At a concentration of 0.61% in ethylene glycol the thermal conductivity enhancement was 53.0%. The nanorods were transferred to water via repeated centrifugation and re-dispersion steps. The final concentration of the silver nanorod solution in water was 0.46% by volume. The thermal conductivity of the nanorod composition was 25.8% greater than the thermal conductivity of water without the nanorods.

### Example 5

### Comparison of the Thermal Conductivity Enhancement of Spherical Silver Nanoparticles to Silver Nanorods

Spherical silver nanoparticles with 20 nm diameters were obtained from Nanotechnologies (Austin, Tex.) in a dried powder form. The spherical silver nanoparticles were dispersed in water at a concentration of 1.5% by volume. The solution was sonicated in a bath sonicator for 10 minutes. The thermal conductivity of the dispersed spherical silver nanoparticles was measured using a Mathis TCi Thermal Conductivity Testing System. At 25° C., the thermal conductivity of the solution was increased by 1.3% over water alone. A solution of silver nanorods was prepared in water at a concentration of 1.5% by volume. The silver nanorod solution increased the thermal conductivity of water by 66%. At the same volume concentration of silver (1.5%), the silver nanorods produced a thermal conductivity enhancement of water that was ˜50 times greater than the enhancement produced by spherical silver nanoparticles.

### Example 6

### Antibacterial Properties of Silver Nanofluids

The addition of nanostructures to fluids can prevent bacterial growth. The bactericidal properties of spherical silver colloid and silver nanorods was measured and compared with the bactericidal properties of silver nitrate. Lyophilized Acidovorax delafieldii (ATCC #17505) bacterium was reconstituted in Difco Nutrient Broth (NB), streaked onto NB agar plates and incubated for 24 hours at 37° C. A single colony was isolated and used to inoculate an NB culture that was grown to mid-log phase where the visibly cloudy solution has an optical density of 0.3 at a wavelength of 600 nm. 10 μL of this preculture (˜2.3×10⁴ CFU/mL) was mixed with 5 mL of NB medium that contained 0.2 mg/mL, 0.02 mg/mL, 2 μg/mL, 0.02 μg/mL, and 0.002 μg/mL concentrations of either silver nitrate (AgNO₃), silver colloid, or silver nanorods. After 28 hours of shaking at 37° C., cultures containing at least 0.2 μg/mL of Ag were visibly clear compared to the untreated control. Viable cells were enumerated by the colony count method on NB agar plates. Table 1 illustrates the effect of silver addition on the growth rates of Acidovorax delafieldii in NB after 28 hours of incubation at 37° C., and shows that at 0.2 μg/mL, colony counts were reduced in all silver samples by at least 6 orders of magnitude. The silver nitrate showed the highest biocide activity since all of the added silver is in the antimicrobial ionic form.

TABLE 1

| No. | Sample | CFU/mL |
|---|---|---|
| 1 | Untreated NB Control | 5.8 × 10⁹ |
| 2 | AgNO₃ (1.9 uM) | 1.2 × 10³ |
| 3 | Silver Colloid (0.002% by vol) | 2.8 × 10³ |
| 4 | Silver Nanorods (0.01% by vol) | 3.1 × 10³ |

What is claimed is:

1. A composition comprising:
a carrier; and
an amount of metal nanorods dispersed in the carrier that is effective to provide the composition with a thermal conductivity that is substantially different from the thermal conductivity of a comparable composition not containing the metal nanorods,
wherein the metal nanorods are characterized by lengths along a first principle axis, a second principle axis and a third principle axis, wherein:
the axial length along the first principle axis is greater than or equal to the axial length along the second principle axis;
the axial length along the second principle axis is greater than or equal to the axial length along the third principle axis;
the axial length along the first principle axis divided by the axial length of the second principle axis is greater than about three; and
at least one of the axial lengths is less than about 500 nm.

2. The composition of claim 1, wherein the amount of metal nanorods dispersed in the carrier is at least about 0.05% by volume of the composition.

3. The composition of claim 1, wherein the amount of metal nanorods dispersed in the carrier is at least about 0.2% by volume of the composition.

4. The composition of claim 1, wherein the thermal conductivity is at least about 5% greater than the thermal conductivity of the comparable composition not containing the metal nanorods.

5. The composition of claim 1, wherein the thermal conductivity of the composition is substantially different from the thermal conductivity of a comparable composition comprising non-nanorod nanostructures in place of the nanorods, wherein the volume concentration of the non-nanorod nanostructures in the comparable composition is substantially the same as the volume concentration of the nanorods in the composition.

6. The composition of claim 1, wherein the axial length along the first axis divided by the axial length of the second axis is greater than about five.

7. The composition of claim 1, wherein at least a portion of the metal nanorods comprise a coating.

8. The composition of claim 7, wherein the coating is substantially electrically insulating.

9. The composition of claim 1, wherein the shortest axial length of the metal nanorods is less than about 200 nm.

10. The composition of claim 1, further comprising an amount of non-nanorod nanostructures.

11. The composition of claim 1, wherein the metal nanorod comprises at least about 30% metal by weight.

12. The composition of claim 1, wherein the metal is selected from gold, silver, copper, nickel, iron, and aluminum.

13. The composition of claim 1, wherein the metal nanorods comprise silver nanorods.

14. The composition of claim 1, wherein the metal nanorods are crystalline.

15. The composition of claim 1, wherein the metal nanorods comprise a non-circular cross-section.

16. The composition of claim 1, wherein the viscosity of the composition is greater than or equal to about 100 cP.

17. The composition of claim 1, wherein the viscosity of the composition is less than about 100 cP.

18. The composition of claim 1, further comprising a surfactant, a colloidal stabilizer, a nanoparticle aggregation inhibitor, an antimicrobial agent, an anti-corrosive agent, a viscosity modifier, or a degradation stabilizer.

19. A method of making a metal nanorod composite material, comprising intermixing a base material with an amount of metal nanorods that is effective to form a composite material having a thermal conductivity substantially different from the thermal conductivity of a comparable composite material not containing the metal nanorods, wherein the metal nanorods are characterized by lengths along a first principle axis, a second principle axis and a third principle axis, wherein:
the axial length along the first principle axis is greater than or equal to the length along the second principle axis;
the axial length along the second principle axis is greater than or equal to the length along the third principle axis;
the axial length along the first principle axis divided by the length of the second principle axis is greater than about three; and
at least one of the axial lengths is less than about 500 nm.

20. The method of claim 19, wherein the metal nanorods comprise silver nanorods.

21. A method of using a metal nanorods composition, comprising contacting a substrate with the metal nanorod composition, wherein the composition comprises metal nanorods dispersed in a base material in an amount effective to form a composite material having a thermal conductivity substantially different from the thermal conductivity of a comparable composition not containing the metal nanorods, wherein the metal nanorods are characterized by lengths along a first principle axis, a second principle axis and a third principle axis, wherein:
the axial length along the first principle axis is greater than or equal to the length along the second principle axis;
the axial length along the second principle axis is greater than or equal to the length along the third principle axis;
the axial length along the first principle axis divided by the axial length of the second principle axis is greater than about three; and
at least one of the axial lengths is less than about 500 nm.

22. The method of claim 21, wherein the substrate is a component of a heating system, a refrigeration system, a cooling system, an air conditioning system, an electronic device, an instrument, a vehicle, an aircraft, a spacecraft, a power-generating system, a thermal storage system, a heat pipe system, a fuel cell system, a hot water system, or an automobile.

23. The method of claim 21, further comprising intermixing the metal nanorod composition with a coolant, thereby increasing the thermal conductivity of the coolant.

24. The method of claim 21, further comprising flowing the metal nanorod composition across the surface of the substrate.

25. The method of claim 21, further comprising positioning the metal nanorod composition in a layer between the substrate and a second surface.

26. The method of claim 21, wherein the contacting of the substrate with the metal nanorod composition provides a thermal conduction pathway to a second surface.

27. The method of claim 21, wherein the metal nanorod composition substantially inhibits growth of microorganisms in the carrier and/or on the substrate.
